(19) United States
(12) Patent Application Publication
(10) Pub. No.: US 2009/0059980 A1
(43) Pub. Date: Mar. 5, 2009

(54) HIGH-STABILITY FREQUENCY REFERENCE BASED ON SELF-LOCKED ALKALI-VAPOR LASER

(76) Inventors: Alan M. Braun, Lawrenceville, NJ (US); Joseph H. Abeles, East Brunswick, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/050,152

(22) Filed: Mar. 17, 2008

Related U.S. Application Data
(60) Provisional application No. 60/895,184, filed on Mar. 16, 2007.

(51) Int. Cl. H01S 3/098

(52) U.S. Cl. 372/38.01

(57) ABSTRACT

Embodiments of the invention are directed to an atomic-based frequency reference that includes an architecture that eliminates the need for local oscillator components and instead is implemented with a “photonic local oscillator,” that provides for a relatively low power consumption, compact, atomic clock/frequency reference. Such a system is based on a laser cavity which contains an alkali-vapor-cell within the laser cavity. The laser cavity is designed to oscillate in two or more optical wavelengths, with the frequency difference of these lasing wavelengths equal to the atomic hyperfine resonance frequency. Embodiments of the system can include relatively few elements, namely: a) an optical gain element with an emission band centered at the atomic absorption band; b) collimating optics; c) an atomic vapor cell; and d) a cavity end mirror. Optionally, specific polarization optics may be used depending on the specifics of the optical pumping.

### CROSS-REFERENCE TO RELATED APPLICATIONS

This application claims the benefit of U.S. provisional patent application No. 60/895,184, filed Mar. 16, 2007, the contents of which are hereby incorporated by reference herein.

### GOVERNMENT RIGHTS IN THIS INVENTION

This invention was made with U.S. government support under contract number N00014-06-C-0078. The U.S. government has certain rights in this invention.

### FIELD OF THE INVENTION

The present invention relates generally to atomic clocks, and more particularly to atomic-based frequency references for atomic clocks.

### BACKGROUND OF THE INVENTION

Atomic clocks have been used in systems that require a very accurate time base or frequency measurement. Typical applications include global positioning systems (GPS) satellites, cellular phone systems, scientific experiments, and military applications. Conventional atomic clocks operate by use of an optical source (typically lamp-based, but some are laser-based) to “pump” atoms into the classical “0-0” state. The “0-0” state is the hyperfine frequency transition between an upper energy level with azimuthal quantum number 0 and total angular momentum quantum number f=I+½ and a lower energy level with azimuthal quantum number 0 and total angular momentum quantum number f=I−½. In such systems, a microwave field is coupled into a microwave cavity enclosing an atomic vapor cell and, operating under feedback control, the microwave frequency of the microwave field is locked to the atomic 0-0 frequency state. The locking on to the atomic 0-0 frequency state by means of an applied microwave frequency field is called RF-interrogation.

The basic architecture of atomic-based sources of stabilized 10 MHz or high-frequency radio frequency (RF) sources has been around for some time. In its most basic form, an electronics frequency oscillator has its frequency stabilized with input from an atomic vapor cell. Used in a passive mode, the frequency oscillator is frequency-multiplied to a value that allows interrogation of an atomic resonance frequency. The output of such atomic-interrogation is an error-signal that is used to adjust the operating frequency of the electronic oscillator, providing a single-frequency output (anywhere from MHz to GHz output frequency) whose frequency is long-term stable. In such a configuration, the electronic oscillator is said to be “disciplined” by the atomic source. The fundamental reasons for using such a system is that conventional electronic oscillators consist of bulk materials whose output frequencies are susceptible to ambient environmental changes, including temperature, pressure, vibration/shock, whereas, to first order, the atomic-vapor used is not susceptible to these environmental effects, providing a source of long-term stable time/frequency reference.

Many different embodiments of this architecture have been employed, with differences in components and integration, yet with similar overall architecture, i.e., an electronic oscillator stabilized by the atomic source, implemented in a feedback loop. There are several basic components of such a system: 1) a low-frequency reference oscillator; 2) local oscillator electronics; i.e., electronics used to multiply up the low-frequency oscillator (typically from the 10 MHz regime) to the atomic resonance frequency (typically in the multiple GHz regime); 3) an atomic-vapor cell with associated optical and/or RF pumping; and 4) detected “error-signal” and feedback control to the low-frequency reference oscillator.

One way to view the obtained stability of such disciplined oscillators is to note that the atomic linewidth from alkali-vapor cells under interrogation is typically a 1 kHz wide line centered at 9.19 GHz (if cesium is used as the alkali-atom of choice), giving a measurable natural resonance Q of 9.19 GHz/1 kHz˜10⁷. However, with high Signal-to-Noise (S/N) implementations, this atomic resonance line can be measured to a much higher fidelity. With feedback electronics, the clock interrogation signal (which becomes the clock output frequency) can determine the peak of the atomic-resonance frequency to a level limited by system S/N ratio such that the atomic line can typically be resolved by an additional 4 orders of magnitude, giving rise to clocks which routinely provide frequency stability at the part in 10¹¹ order.

Therefore, in such implementations, the local oscillator electronics is an inherent part of the atomic clock/frequency reference. However, the local oscillator electronics also imparts noise into the system and as well consumes a large amount of power. While the atomic-vapor cell and associated heating elements can be size and power reduced to a tremendous degree (10 mW power consumptions have been demonstrated), in contrast, the high-frequency local oscillator electronics still consumes at least ten times the power of the other components.

Accordingly, there is a need for an atomic-based frequency reference operated without use of local oscillator electronics, reducing overall power and size requirements as well as enabling high performance stability operation.

### SUMMARY OF THE INVENTION

The above-described problems are addressed and a technical solution is achieved in the art by providing an atomic-based frequency reference.

Embodiments of the invention are directed to an atomic-based frequency reference that includes an architecture that eliminates the need for local oscillator components and instead is implemented with a “photonic local oscillator,” that provides for a relatively low power consumption, compact, atomic clock/frequency reference. Such a system is based on a laser cavity which contains an alkali-vapor-cell within the laser cavity. The laser cavity is designed to oscillate in two or more optical wavelengths, with the frequency difference of these lasing wavelengths equal to the atomic hyperfine resonance frequency.

Embodiments of the system can include relatively few elements, namely: a) an optical gain element with an emission band centered at the atomic absorption band; b) collimating optics; c) an atomic vapor cell; and d) a cavity end mirror. Optionally, specific polarization optics may be used depending on the specifics of the optical pumping.

### BRIEF DESCRIPTION OF THE DRAWINGS

Embodiments of the invention will be more readily understood from the detailed description of exemplary embodiments presented below considered in conjunction with the attached drawings, of which:

FIG. 1 is a schematic diagram showing an intracavity alkali-vapor laser system, in accordance with embodiments of the invention;

FIG. 2 is a schematic diagram showing another embodiment of an intracavity alkali-vapor laser system, in accordance with embodiments of the invention;

FIG. 3 is a schematic diagram showing another embodiment of an intracavity alkali-vapor laser system, in accordance with embodiments of the invention;

FIG. 4 is a schematic diagram showing another embodiment of an intracavity alkali-vapor laser system, in accordance with embodiments of the invention;

FIG. 5 is a perspective view of a two-section, curved waveguide SOA (semiconductor optical amplifier), in accordance with embodiments of the invention; and

FIG. 6 is a perspective view of a gain emitter, in accordance with embodiments of the invention.

It is to be understood that the attached drawings are for purposes of illustrating the concepts of the invention and may not be to scale.

### DETAILED DESCRIPTION OF THE INVENTION

Embodiments of the invention are directed to an atomic-based frequency reference that includes an architecture that eliminates the need for local oscillator components and instead is implemented with a “photonic local oscillator,” as is described in detail below, that provides for a relatively low power consumption, compact, atomic clock/frequency reference. Such a system is based on a laser cavity which contains an alkali-vapor-cell within the laser cavity. The laser cavity is designed to oscillate in two or more optical wavelengths, with the frequency difference of these lasing wavelengths equal to the atomic hyperfine resonance frequency. Such a laser cavity acts as a mode-locked laser cavity, where the cavity length determines the cavity mode spacing and an intra-cavity nonlinear element is used to phase-lock the cavity modes that reside under the gain envelope. In some embodiments, the nonlinear element is the inherent alkali-resonance. With external cavity mode-spacing matched to hyperfine frequency resonance, the alkali hyperfine resonance can act to couple the cavity longitudinal modes, allowing oscillation at two or more optical frequencies, with the frequency difference equal to alkali hyperfine frequency. In general, the output of such a device is a “comb” of two or more optical modes (also referred to herein as optical tones) which could be used as is, or, alternatively, when focused onto a high-bandwidth photodiode, outputs an RF frequency tone of frequency equal to this optical frequency difference. Due to intracavity nonlinear gain narrowing experienced in all laser resonators (as is known to those of skill in the art), the coherent oscillating optical tone linewidths narrow, and more importantly, result in a narrowing of the generated RF frequency output. Such narrowing, up to an order of 10⁶, will results in RF output frequency reference with mHz-to-Hz linewidth, i.e., an output RF resonance Q of 10¹⁰ to 10¹³. The output from a high-bandwidth photodiode can be utilized directly as a stabilized RF source, for example as a frequency reference for a Radar or communications application, or can be coherently divided to a more traditional (e.g., 10 MHz) with subsequent parsing of the RF frequency to provide an additional four orders of magnitude improvement in frequency stability.

Embodiments of the system, also referred to herein as an optical resonator, all utilize the nonlinear gain feedback from the alkali-vapor cell within the laser cavity, to phase-lock the lasing modes, and may use direct feedback of some of the detected RF frequency to stabilize the external-cavity mode spacing or to actively drive the optical gain element as a means to start and sustain multi-longitudinal mode lasing. In either event, the main optical laser cavity can be a direct current (DC) current bias with no high-frequency local oscillator components needed. The system can include relatively few elements, namely: a) an optical gain element with an emission band centered at the atomic absorption band (e.g., 894 nm for cesium D1-line pumping); b) collimating optics; c) an atomic vapor cell; and d) a cavity end mirror. Optionally, specific polarization optics may be used depending on the specifics of the optical pumping.

In some embodiments the clock output RF (9.19 GHz direct output from the high-speed photodetector in the case of cesium) could have a frequency stability at the part in 10¹⁰ level or better. With coherently-stabilized division down to 10 MHz, clock stability approaching 10¹⁴ could be achieved.

By way of certain embodiments, an external-cavity laser incorporating an alkali-vapor cell is used as self-locked clock. An aspect of such a laser clock is that an external-cavity clock incorporating an alkali-vapor cell oscillates with multiple phase-locked optical lines with optical tone spacing dictated by an intracavity alkali vapor cell. External cavity resonator length is adjusted and maintained with a round-trip cavity frequency equal to the alkali hyperfine frequency. The alkali vapor is subsequently optically pumped by the gain media, with alkali resonance peak (peak in alkali-vapor transmission, or minimum in cavity loss) used to maintain phase-locked cavity mode spacing. This alkali-vapor transmission peak is the point of lowest cavity losses, therefore the system will adjust to maintain operation at this peak, providing a “photonic local oscillator” to maintain the frequency spacing of the oscillating lasing modes. Any number of alkali vapor transitions can be implemented, but those providing high contrast resonance signals provide highest gain discrimination, maintaining cavity locking. Such transitions could include 0-0, end-state (as described in U.S. Pat. No. 6,919,770, the contents of which are hereby incorporated by reference herein) or alternating-polarization pumped 0-0 (as described in U.S. Pat. No. 7,102,451, the contents of which are hereby incorporated by reference herein), or others. This optically-pumped gain discrimination resonance is the state of lowest cavity loss, and hence the alkali-vapor cell will maintain the needed optical cavity modes with correct phase relationship to maintain resonance. Said another way, the alkali-atoms modulate the optical tones, and as these tones are reinforced by the external-cavity resonator and gain media, the optical tones share energy in phase and become phase locked. Should the atomic resonance Q be stronger than the external cavity resonator Q, then the lasing mode spacing will be dominated by the intracavity alkali-vapor, not external cavity modes, minimizing cavity pulling effects.

By way of some embodiments, generated optical tones linewidth, and hence the microwave signal linewidth as seen following high-speed photodetector of the optical frequency difference, are greatly narrowed due to the effect of a nonlinear van der Pol oscillator within the laser cavity. As in all laser resonators, the cold-cavity linewidth is greatly narrowed, up to an order of 10⁶, by fact of nonlinear oscillation within the resonator. As each of the two- or more phaselocked modes will also be gain-narrowed, so too will the resulting frequency difference between these modes, resulting in a detected RF frequency of narrow linewidth. This microwave tone linewidth narrowing results in RF frequency with linewidth much reduced from that of natural alkal-vapor cell resonance linewidth and hence provides the orders-of-magnitude improved stability than what traditionally occurs in electronic-feedback clock systems.

Optical linewidth reduction is typical in traditional laser oscillators due to nonlinear gain feedback. In contrast, by way of embodiments of the invention, a novel effect is reduction in linewidth of a microwave clock signal which, upon detection with a high speed photodetector, yields a system clock frequency in the GHz regime (e.g., using rubidium or cesium as the alkali atom) with Hz-to-mHz frequency resolution, i.e. detected resonance Q's of 10⁹ to 10¹². This source can be used directly as a frequency reference for RF systems or as stable tone for further linewidth parsing. For example, operated in a feedback-loop with a 10 MHz crystal oscillator, the output 10 MHz signal can have enhanced frequency resolution by up to four orders of magnitude.

Embodiments of the invention utilizes compact, low-mass components, without need for a microwave cavity or (under certain circumstances) more importantly, without need for local oscillator electronics, allowing for a compact clock/frequency reference system relatively insensitive to high acceleration environments and low-power DC power consumption.

Embodiments of the invention can include any one of several methods of optical pumping techniques to providing a high-contrast atomic resonance signal as would be known to one of skill in the art. For example, traditional 0-0 optical pumping could be implemented. Alternatively, one of a number of more sophisticated approaches designed to achieve stronger gain-discrimination can be utilized, such as end-state pumping or push-pull 0-0 pumping, as is known to those of skill in the art.

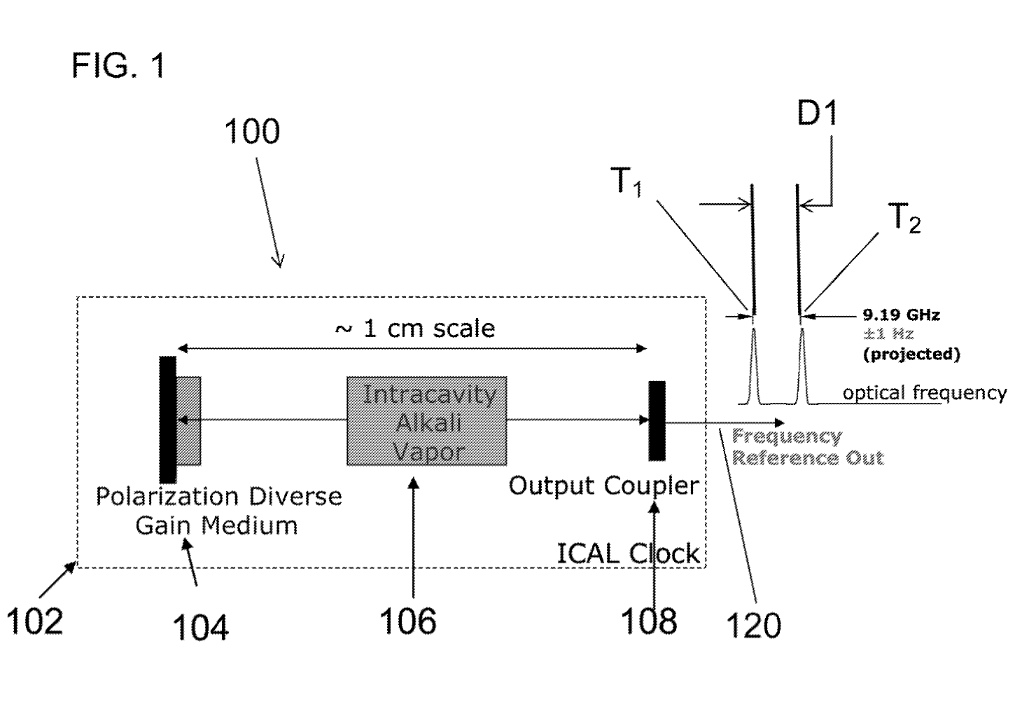

With reference to FIG. 1, there is shown an intracavity alkali-vapor laser system 100. System 100 includes an optical cavity 102, an optical gain element 104, an alkali-vapor cell 106, and an optical cavity end mirror (output coupler) 108. The output 120 is two or more optical tones T1, T2, separated by a frequency difference D1 equal to the atomic line hyperfine splitting.

Optical cavity 102 is a laser resonator, preferably a linear cavity but a ring-cavity could be implemented, such that the round-trip cavity mode spacing is equal to or a harmonic of the alkali-vapor cell hyperfine frequency. The cavity round-trip offers a filter function, re-enforcing cavity modes of frequency multiple of c/(2*n*L) where c is the speed of light, n is the effective index-of-refraction of the cavity, and L is the single-pass cavity spacing. Cavity is adjusted in length to provide length L needed to provide cavity mode spacing, or multiple thereof, to match alkali-vapor cell frequency. Feedback from photodiode signal can be used to maintain cavity length. Gain element 104 is the gain media needed to provide the optical energy for the system 100. This gain element 104 sustains lasing oscillation and can also provide the end-mirror reflection for one end of the laser cavity. This gain element 104 could be a semiconductor diode gain element with optical emission designed to overlap the alkali-atom absorption band. Alternatively, gain element 104 could be a suitable solid-state gain media. Cell 106 is the alkali-vapor cell, used as the gain-discrimination element and used to coherently lock the allowing lasing tones. Such an alkali-vapor cell 106 is generally heated to provide adequate alkali-vapor density, along with applied DC magnetic fields for alignment of atomic spin polarization. This vapor cell 106 should be of sufficiently thin physical dimension to fit within the laser cavity resonator. Vapor cell 106 may contain appropriate buffer-gas for minimizing wall collision effects, as known in the state of the art. Mirror 108 is a cavity end mirror, employed to provide optical feedback and round-trip oscillation and placed at a position to allow the cavity mode frequency spacing to equal the alkali-vapor hyperfine frequency. Broad-band light is emitted from the gain-element 104 and propagates through alkali-cell 106 to end-mirror 108 and back through alkali-cell 106 to gain element 104. The cavity round-trip offers a filter function, re-enforcing cavity modes of frequency multiple of c/(2*n*L) where c is the speed of light, n is the effective index-of-refraction of the cavity 102, and L is the single-pass cavity spacing. The alkali vapor cell 106 is arranged such that two or more of these lasing tones optically pumps the atoms into a state where the alkali-cell 106 has a transmission resonance peak, i.e. a state of lowest loss through the vapor cell. These optical tones see low loss propagation through the alkali cell 106 and hence experience preferred gain at that gain media, 104. Upon many round trips, these preferred optical tones reach a steady-state, along with the alkali-vapor cell reaching a steady-state low-loss resonance peak, and these optical tones become locked in phase, i.e. mode-locked.

As shown in FIG. 1, the self-locked clock system 100 can be viewed as a modelocked laser cavity 102, with the atomic vapor cell 106 acting as the saturable absorber media or active modelocking element. As in traditional modelocked laser cavities, the cavity resonance spacing plays a key role in determining the optical mode spacing. In such laser resonators, the cavity mode spacing is determined by the round-trip standing-wave condition, or frequency difference δv_{cavity}=c/(2*n*L) where c is the speed of light, n is the effective index-of-refraction of the cavity, and L is the single-pass cavity spacing. Hence, there are many possible modes that satisfy the standing wave condition, each of frequency difference frequency difference δv_{cavity}. Coupled with this is the gain-bandwidth which limits the number of modes that can experience gain>loss and sustain oscillation.

In typical lasers running in a CW (continuous wave) mode, only the one cavity mode with the highest gain experiences self-sustained oscillation, at the expense of all other modes. However, if the various cavity modes are coupled via an intracavity nonlinearly (e.g., alkali cell 106), then a multitude of cavity modes can laser coherently, in which case the laser is said to be mode-locked. In traditional active modelocked laser cavities, an RF is applied with a frequency that is equal to the cavity mode spacing, allowing sharing of energy and locking the cavity modes in phase. In passive modelocked systems, a saturable absorber element is used as a nonlinearity needed to prefer pulsed, as opposed to CW lasing. Such coherent pulsing is the Fourier-domain analogy to optical comb lasing. In embodiments of the system 100, the alkali-vapor cell 106 possesses an intrinsic nonlinear resonance, which if multiple optical tones are positioned with a specific frequency difference, phase, and polarization, will drive the alkali cell 106 to a state of less loss (higher-transmission), which will reinforce these optical tone properties upon every pass through the cavity, eventually leading to self-starting and stable cavity tone oscillation. In such a case, the external cavity resonance (path-length) can be set to be equal to or a multiple of the atomic hyperfine splitting separation, e.g., the cavity round-trip frequency will match the alkali hyperfine frequency. For cesium, with a hyperfine frequency of ˜9.19 GHz, the cavity 102 will have a similar or harmonic round-trip frequency, or a single-pass cavity length of ˜1.6 cm or harmonic thereof.

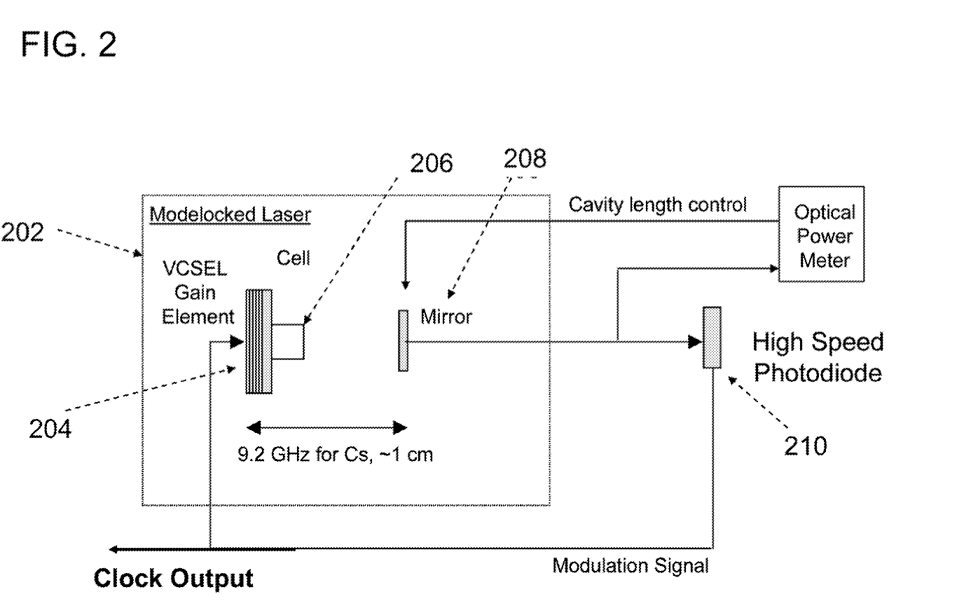

With reference to FIG. 2, there is shown a self-locked clock system 200 similar to system 100 shown in FIG. 1, but implemented with a specific vertical cavity surface emitter laser (VCSEL) gain element 204, and a high-speed photodetector (photodiode) 210 which can convert the optical frequency comb output into a single RF frequency by detecting the optical frequency difference. As is known to those of skill in the art, the VCSEL laser is a specific type of semiconductor laser with very-low threshold currents, low power consumption. The high-speed photodetector 210 is employed to detect the frequency difference between the lasing tones and extract the clock signal. In some embodiments, the output from the high-speed photodiode 210 can be used directly as an RF source, used with some power feedback to stabilize the optical resonator or further parsed to achieve a 10 MHz output, for example.

With continued reference to FIG. 2, a passive feedback from the detected RF signal to the gain element 204 can facilitate reinforcing and stabilizing the RF frequency optical frequency difference. This feedback provides modulation of the gain element 204, effectively modulating the cavity loss at the same roundtrip rate. This modulation causes the cavity modes to become phase locked. Viewed in the Fourier-domain, such a modulation causes a pulse to circulate in the cavity, reappearing on every round-trip of propagation through the cavity at that part of the modulation waveform that is promoting the lowest cavity loss. The detected RF frequency is used to modulate the carriers of the gain element, enhancing and reinforcing the ability of the cavity to mode-lock the optical tones. In this way, the system is actively modelocked, but with the drive modulation self-generated, not derived from local-oscillator electronics.

As an example, choosing the case of cesium atoms as the alkali-atom of choice: the hyperfine frequency for cesium is ˜9.19 GHz. For a cavity to support cavity-modes spaced by 9.19 GHz implies a round-trip path-length of ˜3.2 cm (assuming an effective index-of-refraction of about 1.0) and hence a linear-resonator path length from end-mirror to end-mirror of 1.6 cm. The optical absorption band for cesium is about at 894 nm, or ˜335,100 THz (3.35080×10¹⁴ Hz). Therefore, the two main oscillating optical tones that the gain media would support and that would interact and become coupled and phase-locked through interaction with the cesium vapor cell would be approximately centered at 335080 GHz and 335070.81 GHz. These values are approximate, and are meant for exemplary purposes. Other values my be used in accordance with embodiments of the invention.

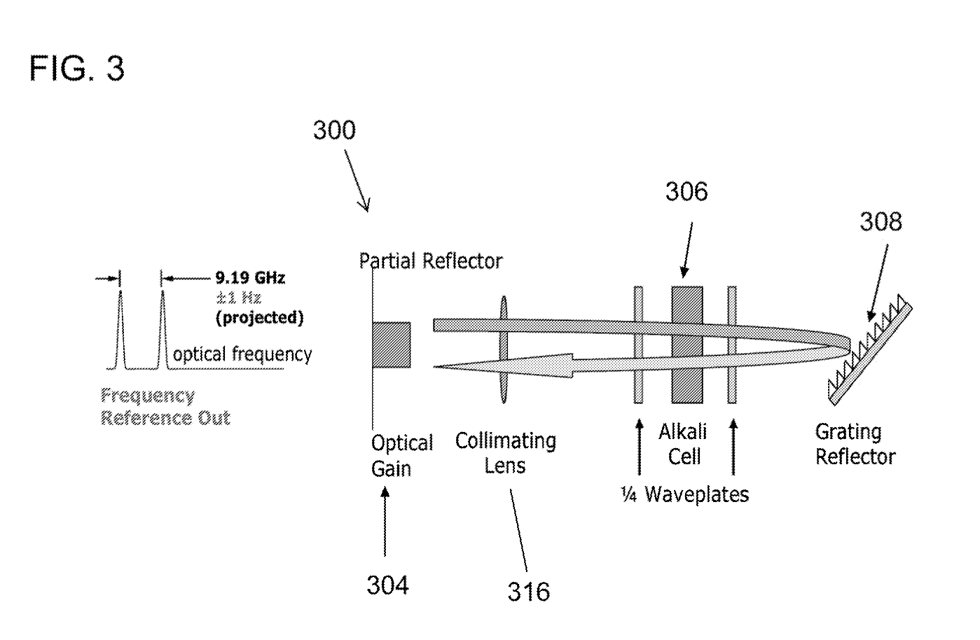

With reverence to FIG. 3, there is shown a system 300, which is another embodiment of systems 100 and 200 discussed above. In system 300, a cavity end-mirror 308 can be a grating reflector used to both fix the center optical frequency to match the atomic absorption band, as well as to narrow the optical cavity bandwidth to be less than the bandwidth of the cesium absorption band. Such an arrangement can prevent the lasing cavity from lasing at an optical frequency outside the alkali absorption band. In this embodiment, the grating 308 is acting both as the cavity end-mirror and as an optical bandwidth controlling element. The cavity end-mirror 308 is employed to provide optical feedback and “close” the optical resonator. This feedback propagates back through the alkali-vapor cell 306 and to the gain media 304, where the optical losses are replenished with optical gain. At the condition where roundtrip losses equals gain, the cavity can lase and achieve self-sustained oscillation. The cavity end-mirror 308 can also be configured to provide optical bandwidth selection, as the optical bandwidth needs to be matched to the alkali-atom absorption band.

In this embodiment, the specific output end-mirror 308 is determined to be a grating (bulk diffraction grating or equivalent Volume Bragg Grating (VBG), for example) to have an optical element that is forcing the optical cavity to lase at a particular wavelength band, matched to the alkali absorption band. The diffraction grating 308 can also be used to set the optical cavity free-running bandwidth to be a particular bandwidth, either to match, exceed, or be narrower than the alkali absorption bandwidth.

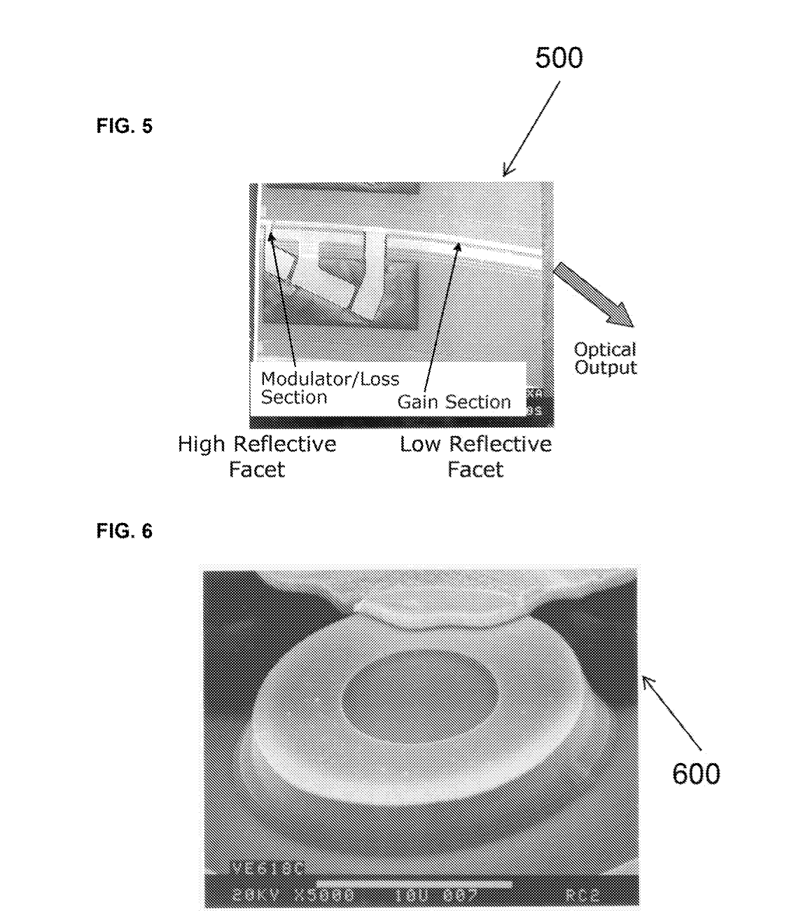

With continued reference to FIG. 3 and FIG. 1, the gain element 304 used could be a broadband gain element so that only the external cavity with the alkali-vapor cell 306 determines precise lasing frequencies. Such a gain element 304 could be an edge-emitting SOA (semiconductor optical amplifier) or a version including gain and modulation sections, low front-facet reflectivity (through either good AR coatings or curved-waveguide implementation (as would be known to those of skill in the art, as informed by the present disclosure)) and integrated cavity end-mirror/output coupler on back cavity facet (See FIG. 5, discussed below). In some lowest-power implementations, a VCSEL gain element 304 can be utilized. Such VCSEL emitters are used within chip-scale atomic clocks to provide a milli-watt power consumption optical source, as is known to those of skill in the art.

The alkali-vapor cell 306 could be a commercial glass-blown cell or a batch-fabricated cell fabricated with silicon/pyrex anodic bonding techniques with either low or high buffer-gas pressures. Traditional atoms include Rubidium and Cesium, although others such as potassium could be utilized.

Depending on the specific atomic transition being implemented for “dark-line” high transmission, resonant gain-discrimination, polarization optics and focusing/collimating optics may be included inside the optical resonator, as would be known to those of skill in the all, as informed by the present disclosure (e.g., ¼-waveplates are shown in FIG. 3. Such a configuration is designed for alternating-polarization “push-pull” pumping to the 0-0 transition). Further appropriate DC bias magnetic fields and magnetic shielding could also be used to maximize atomic resonance signal and prevent unwanted stray fields from disrupting operation.

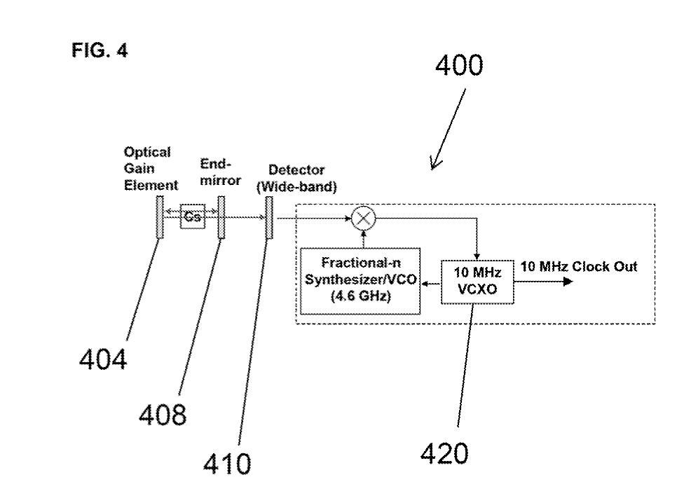

With reference to FIG. 4, there is shown a system 400, similar to those of systems 100, 200 and 300 described above, except that following the high-speed photodiode 410, the RF signal is coherently (phase-sensitive) used as the master resonance to which a 10 MHz crystal oscillator 420 is disciplined. Such an arrangement allows for effective frequency division to a more common frequency (e.g., 10 MHz) while allowing further parsing of the highly stabilized RF resonance frequency by up to four orders of magnitude, resulting in signal Qs approaching 10¹⁴.

With reference to FIGS. 5 and 6, there is shown exemplary gain elements that could be utilized, in accordance with embodiments of the invention. With reference to FIG. 5, a two-section, curved waveguide SOA (semiconductor optical amplifier) with broadband emission centered at an atomic absorption band 500 is shown. This device offers integration of multiple functions including providing broadband gain and active modulation as well as integrating cavity end-mirror on the back facet of the device. Such waveguides are described, for example, in U.S. Pat. No. 7,164,699, the contents of which are hereby incorporated by reference herein.

With reference to FIG. 6, a VCSEL gain emitter 600 designed for emission at the alkali absorption band and emission polarization specific for optical pumping of alkali-atoms is shown.

Thus, embodiments of the invention are directed to an external-cavity laser incorporating an alkali-vapor cell, and is used as self-locked laser clock. An aspect of such a laser clock is that an external-cavity clock oscillates in multiple phase-locked optical lines with optical tone spacing dictated by an intracavity alkali vapor cell, minimizing cavity pulling effects.

Embodiments of the invention can have one or more of the following benefits: compact size; elimination of RF electronics, thus providing an all-optical alkali-vapor intracavity laser; and increased system sensitivity as light propagates multi-times through the alkali-vapor cell within the laser cavity.

Embodiments can achieve a high performance frequency standard as the optical tones linewidth and effective microwave signal linewidth (as seen in the photodetected optical frequency difference) are greatly narrowed due to the effect of nonlinear van der Pol oscillator (laser cavity) (i.e., nonlinear feedback gain).

Embodiments of the invention can be used directly as a frequency reference or as a stable tone for further linewidth parsing.

Certain embodiments, due to the elimination of RF electronics, provide improved system performance due to the elimination of RF noise sources.

In some embodiments the elimination of relatively power-hungry local oscillator electronics provides for great savings in power.

Thus, embodiments of the invention utilize compact, low mass components, without the need for microwave cavity or (in certain circumstances) more importantly, without need for local oscillator electronics, allowing for a compact clock/frequency reference system insensitive to high acceleration environments.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed is:

1. An external cavity laser system comprising:
a cavity having a plurality of cavity modes;
an alkali-vapor cell disposed within the cavity;
a gain medium disposed within the cavity, and adjacent the alkali-vapor cell; and
an output coupler disposed within the cavity, and adjacent the alkali-vapor cell;
wherein the gain medium, the alkali-vapor cell, and the output coupler are arranged and configured such that two or more of the cavity modes are phase locked.

2. The system of claim 1, wherein the cavity mode spacing is matched to the hyperfine frequency of the alkali-vapor cell.

3. The system of claim 1, wherein the phase locked cavity modes are line-narrowed by nonlinear gain discrimination.

4. The system of claim 1, further comprising:
a high speed photodetector to convert the phase locked cavity modes to a stable radio frequency (RF) frequency.

5. The system of claim 4, wherein the stable RF frequency is line narrowed, producing a linewidth narrower than natural alkali-atom linewidth,

6. The system of claim 1, further comprising:
a high speed photodetector to convert the phase locked cavity modes to a stable clock output.

7. The system of claim 1, wherein the output coupler comprises a grating reflector, the grating reflector being shaped to narrow the optical cavity bandwidth.

8. The system of claim 4, further comprising:
a crystal oscillator, wherein the output from the photodetector is used to as a master reference by which the crystal oscillator is disciplined.
